(19) United States
(12) Patent Application Publication
(10) Pub. No.: US 2014/0361725 A1
(43) Pub. Date: Dec. 11, 2014

(54) POWER STORAGE CONTROL DEVICE, POWER STORAGE CONTROL DEVICE CONTROL METHOD, PROGRAM AND POWER STORAGE SYSTEM

(71) Applicant: OMRON Corporation, Kyoto (JP)

(72) Inventors: Takeo Nishikawa, Kyoto (JP); Wataru Okada, Kyoto (JP); Junichiro Yamada, Kyoto (JP); Makoto Ohashi, Kyoto (JP); Yoshinori Sunahata, Shiga (JP)

(73) Assignee: OMRON CORPORATION, Kyoto (JP)

(21) Appl. No.: 14/373,446

(22) PCT Filed: Jan. 24, 2013
(86) PCT No.: PCT/JP2013/051377

§ 371 Date: Jul. 21, 2014

(30) Foreign Application Priority Data
Feb. 28, 2012 (JP) 2012-041983

(51) Int. Cl. H02J 7/35; H02J 7/00

(52) U.S. Cl. CPC H02J 7/35; H02J 7/007; H02J 2007/0095
USPC 320/101

(57) ABSTRACT

The present disclosure relates to a power storage control device, a power storage control device control method, a program and a power storage system which can enhance reliability more. The power storage control device has: an AC/DC converter which converts power supplied from a power system; a DC/DC converter which converts power outputted from a storage battery which stores power; and a control unit which is driven by the power outputted from the AC/DC converter and the power outputted from the DC/DC converter, and controls charging and discharging of the storage battery. Further, in the power storage control device, a voltage value of the power outputted from the AC/DC converter is set higher than a voltage value of the power outputted from the DC/DC converter. The present technology is applicable to, for example, a power storage system.

### TECHNICAL FIELD

The present invention relates to a power storage control device, a power storage control device control method, a program and a power storage system. More particularly, the present invention relates to a power storage control device, a power storage control device control method, a program and a power storage system which can enhance reliability more.

### BACKGROUND ART

In recent years, a demand for a solar power generation system formed by a combination of a solar panel and a storage battery is increasing to take advantage of natural energy and use as a measure for disasters. Generally, the solar power generation system needs to perform power control using a power storage system including a storage battery since there are time zones in which supply of power generated by a solar panel and a demand for power consumed by a load do not match.

Meanwhile, when a control device which controls a power storage system including a storage battery is configured to obtain power only from a power system, the control device cannot be driven when blackout occurs, and therefore the power storage system sometimes stops operating. Further, when a control device is configured to obtain power only from a storage battery of a power storage system, the power storage system cannot be activated in an initial state where power is not stored in the storage battery.

Hence, for example, a control device may be configured to obtain power from a plurality of power sources. However, when, for example, a control device is configured to obtain power from a storage battery of a power storage system and an auxiliary secondary battery, the auxiliary secondary battery deteriorates, and therefore requires maintenance.

Patent Document 1 discloses a fuel cell power generating device which can switch between a commercial power source and a fuel cell as a power supply route to a control circuit according to a situation.

Further, Patent Document 2 discloses a control power source circuit in which output of direct-current power source voltage supplied from a storage battery is lower than that of a direct-current power supply voltage obtained from an alternating-current input supplied from the power system through a rectifier.

### PRIOR ART DOCUMENTS

### Patent Documents

Patent Document 1: Japanese Unexamined Patent Publication No. 2008-135200

Patent Document 2: Japanese Unexamined Patent Publication No. 2008-283788

### SUMMARY OF THE INVENTION

### Problems to be Solved by the Invention

By the way, a system disclosed in Patent Document 1 uses a switch which switches a power supply route to a control circuit. For example, predicting occurrence of blackout is difficult, and therefore it is not possible to switch the power supply route in advance in preparation for occurrence of blackout. Hence, when blackout occurs while a control circuit obtains power from a commercial power source, the switch cannot switch a power supply route and the control circuit stops.

Hence, providing a more reliable power storage system which can continue operating by being configured to supply power to a control circuit without switching a power supply route even when blackout occurs is demanded. Further, conventionally, when power charged in a storage battery is consumed after blackout occurs and a power storage system stops operating, it is difficult to operate again the power storage system before recovery from blackout.

The present disclosure has been made in light of this situation, and can enhance reliability more.

### Means for Solving the Problem

A power storage control device according to one aspect of the present disclosure has: a first power converter configured to convert power supplied from a power system; a second power converter configured to convert power outputted from a storage battery configured to store power; a controller configured to be driven by the power outputted from the first power converter and the power outputted from the second power converter, and control charging and discharging of the storage battery; and a third power converter configured to convert power outputted from a power generating device configured to generate power using natural energy, and output the power to the controller, and a voltage value of the power outputted from the first power converter is set higher than a voltage value of the power outputted from the second power converter.

According to a control method or a program according to one aspect of the present disclosure, a voltage value of the power outputted from the first power converter is set higher than a voltage value of the power outputted from the second power converter, and the control method or the program includes a step of performing control of supplying the power outputted from the power generating device to the storage battery when it is determined that activation is performed using the power outputted from the power generating device through the third power converter and supply of the power continues for a certain period of time after the activation.

A power storage system according to one aspect of the present disclosure has: a storage battery configured to store power; a first power converter configured to convert power supplied from a power system; a second power converter configured to convert power outputted from the storage battery; a controller configured to be driven by the power outputted from the first power converter and the power outputted from the second power converter, and control charging and discharging of the storage battery; and a third power converter configured to convert power outputted from a power generating device configured to generate power using natural energy, and output the power to the controller, and a voltage value of the power outputted from the first power converter is set higher than a voltage value of the power outputted from the second power converter.

According to one aspect of the present disclosure, a voltage value of the power outputted from the first power converter is set higher than a voltage value of the power outputted from the second power converter.

### Effect of the Invention

According to one aspect of the present disclosure, it is possible to enhance reliability more.

### BRIEF DESCRIPTION OF THE DRAWINGS

FIG. 1 is a block diagram illustrating a configuration example of a power storage control device of a first embodiment to which the present technology is applied.

FIG. 2 is a view illustrating a power supply route to a control unit upon a normal time.

FIG. 3 is a view illustrating a power supply route to the control unit upon blackout.

FIG. 4 is a view illustrating a power supply route to the control unit while a relay operation is checked.

FIG. 5 is a view illustrating a power supply route to the control unit when blackout occurs while the relay operation is checked.

FIG. 6 is a flowchart explaining processing performed when blackout occurs while the relay operation is checked.

FIG. 7 is a block diagram illustrating a configuration example of a power storage control device of a second embodiment to which the present technology is applied.

FIG. 8 is a view explaining a power supply route to the control unit upon a normal time.

FIG. 9 is a view illustrating a power supply route from a maintenance power source.

FIG. 10 is a view illustrating a power supply route upon blackout.

FIG. 11 is a view illustrating a power supply route from a storage battery.

FIG. 12 is a view illustrating a power supply route from an autonomous output terminal.

FIG. 13 is a flowchart explaining activation processing.

### MODE FOR CARRYING OUT THE INVENTION

Hereinafter, a specific embodiment to which the present technology is applied will be described in detail with reference to the drawings.

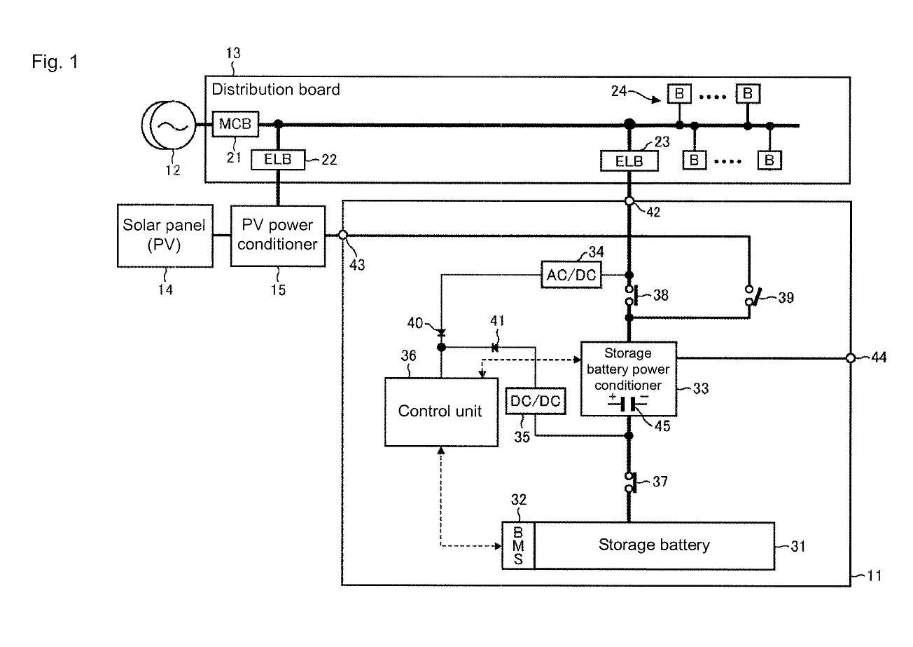

FIG. 1 is a block diagram illustrating a configuration example of a power storage control device of a first embodiment to which the present technology is applied.

As illustrated in FIG. 1, power storage control device 11 is connected with power system 12 which supplies power from a commercial power source, through distribution board 13, and is connected with solar panel 14 through PV (Photovoltaic) power conditioner 15. Further, distribution board 13 and PV power conditioner 15 are connected with each other.

Distribution board 13 includes molded case circuit breaker (MCB) 21, earth leakage circuit breakers (ELB) 22 and 23, and a plurality of circuit breakers 24 which are connected with each other. Molded case circuit breaker 21 is connected with power system 12, earth leakage circuit breaker 22 is connected with PV power conditioner 15, earth leakage circuit breaker 23 is connected with power storage control device 11 and the plurality of circuit breakers 24 are connected with each load which is not illustrated. For example, power supplied from power system 12 and PV power conditioner 15 is distributed to power storage device 11 and the loads connected to the plurality of circuit breakers 24 through distribution board 13. Further, power stored in power storage control device 11 is distributed to the loads connected to the plurality of circuit breakers 24 through distribution board 13.

Solar panel 14 is a panel formed by being connected with a plurality of solar battery modules, and generates power according to an irradiance of sunlight.

PV power conditioner 15 adjusts a voltage of power generated by solar panel 14 to obtain maximum power from solar panel 14, for example. Further, PV power conditioner 15 DC/AC (Direct Current/Alternating Current)-converts the power generated by solar panel 14, and outputs the power to distribution board 13. Furthermore, PV power conditioner 15 has an autonomous output terminal which outputs power when, for example, blackout occurs, and this autonomous output terminal is connected to power storage control device 11.

Power storage control device 11 has storage battery 31, battery management system (BMS) 32, storage battery power conditioner 33, AC/DC converter 34, DC/DC (Direct Current/Direct Current) converter 35 and control unit 36. Further, wirings inside power storage control device 11 are connected with relays 37 to 39 which control power supply routes, and reverse flow preventing units 40 and 41. Furthermore, connection terminals 42 to 44 are disposed in a casing of power storage control device 11, and connection terminal 42 is connected with distribution board 13, connection terminal 43 is connected with the autonomous output terminal of PV power conditioner 15 and connection terminal 44 is connected with a load which is not illustrated.

Inside power storage control device 11, storage battery 31 and storage battery power condition 33 are connected through relay 37, and storage battery power conditioner 33 and connection terminal 42 are connected through relay 38. Further, a wiring between storage battery power conditioner 33 and relay 38, and connection terminal 43 are connected through relay 39, and storage battery power conditioner 33 and connection terminal 44 are directly connected. Furthermore, a wiring between connection terminal 42 and relay 38 is connected with an input terminal of AC/DC converter 34, and an output terminal of AC/DC converter 34 is connected to control unit 36 through reverse flow preventing unit 40. Still further, a wiring between storage battery power conditioner 33 and relay 37 is connected with an input terminal of DC/DC converter 35, and an output terminal of DC/DC converter 35 is connected to control unit 36 through reverse flow preventing unit 41.

Storage battery 31 stores power supplied from storage battery power conditioner 33. Further, the power stored in storage battery 31 is supplied to storage battery power conditioner 33, and is supplied to control unit 36 through DC/DC converter 35.

Battery management system 32 communicates with control unit 36 to manage storage battery 31. For example, battery management system 32 measures a voltage value of the power stored in storage battery 31, a current value of power inputted and outputted to and from storage battery 31 and a temperature of storage battery 31, and transmits these measurement values to control unit 36.

Storage battery power conditioner 33 communicates with control unit 36 to adjust power inputted and outputted to and from storage battery 31 according to a charged state of storage battery 31. For example, storage battery power conditioner 33 AC/DC-converts power supplied from power system 12 through distribution board 13 or power generated by solar panel 14 and supplied through PV power conditioner 15 according to a storage capacity of storage battery 31, and supplies the power to storage battery 31. Further, storage battery power conditioner 33 DC/AC-converts the power stored in storage battery 31, and supplies the power to the loads connected to distribution board 13. Furthermore, storage battery power conditioner 33 DC/AC-converts the power stored in storage battery 31 upon, for example, blackout, outputs (autonomously outputs) power from connection terminal 44 and supplies the power to the load connected to connection terminal 44.

In this way, storage battery power conditioner 33 is configured to bidirectionally convert (AC/DC-convert and DC/AC-convert) power, and has built-in smoothing capacitor 45 of a relatively large capacity on the DC side (a side connected with storage battery 31). Power corresponding to the storage capacity is stored in smoothing capacitor 45 when storage battery power conditioner 33 converts power.

AC/DC converter 34 AC/DC-converts power supplied from distribution board 13 or storage battery power conditioner 33, and supplies the power to control unit 36 through reverse flow preventing unit 40.

DC/DC converter 35 DC/DC-converts power supplied from storage battery 31 or storage battery power conditioner 33, and supplies the power to control unit 36 through reverse flow preventing unit 41.

Control unit 36 has, for example, a CPU (Central Processing Unit), a memory and an input/output interface, and the CPU executes a program stored in the memory to control each unit of power storage control device 11 through the input/output interface. For example, control unit 36 controls storage battery power conditioner 33 based on a measurement value obtained by communicating with battery management system 32 to adequately charge storage battery 31. Further, control unit 36 performs control of opening and closing relays 37 to 39 when necessary.

Relays 37 to 39 switch on/off (a closed state and an opened state) of respective wirings according to the control of control unit 36. Further, relays 38 and 39 are configured to mutually and exclusively turn on wirings, and, when relay 38 is on, relay 39 is turned off and, when relay 39 is on, relay 38 is turned off. That is, relays 38 and 39 are configured to connect one of distribution board 13 and PV power conditioner 15 to storage battery power conditioner 33.

Reverse flow preventing units 40 and 41 regulate directions of currents such that the power outputted from AC/DC converter 34 and the power outputted from DC/DC converter 35 are inputted only to control unit 36.

Power storage control device 11 is configured in this way, and control unit 36 receives a supply of the power supplied from power system 12 through AC/DC converter 34, and receives a supply of the power stored in storage battery 31 through DC/DC converter 35. Hence, according to power storage control device 11, control unit 36 can continue to be driven by the power stored in storage battery 31 when, for example, blackout occurs. Consequently, it is possible to improve reliability of power storage control device 11.

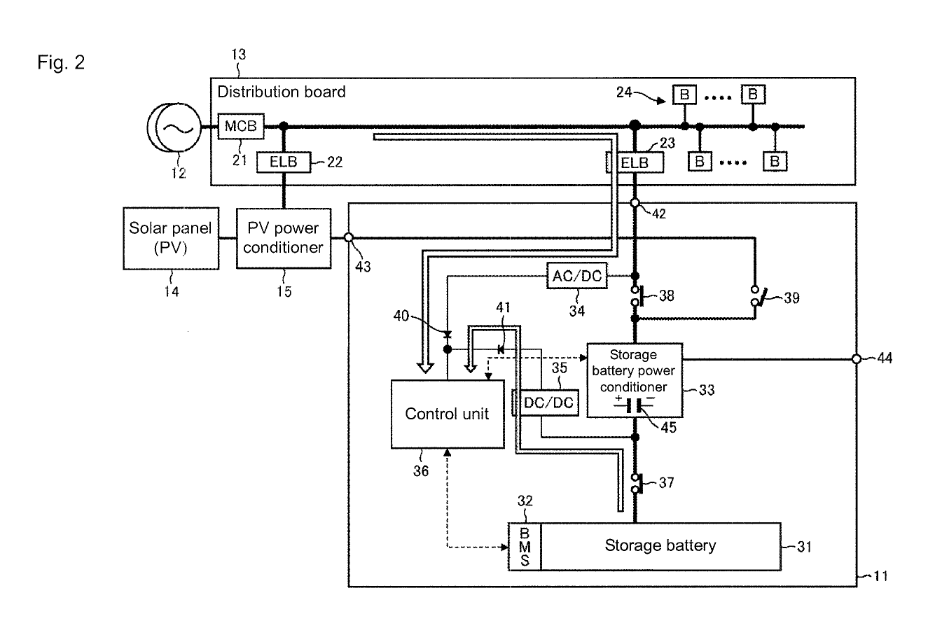

A route of power supplied to control unit 36 will be described with reference to FIG. 2.

FIG. 2 illustrates power routes to control unit 36 upon a normal time when blackout does not occur, as outlined arrows. That is, upon a normal time, the power supplied from power system 12 to power storage control device 11 through distribution board 13 is AC/DC-converted by AC/DC converter 34 and is supplied to control unit 36 along a power supply route indicated by the bold outlined arrow. Similarly, the power outputted from storage battery 31 is DC/DC-converted by DC/DC converter 35 and is supplied to control unit 36 along a power supply route indicated by a thin outlined arrow.

In this regard, in power storage control device 11, a voltage value of an output voltage of AC/DC converter 34 is set higher than a voltage value of an output voltage of DC/DC converter 35 in a range of an operable voltage of control unit 36. More specifically, when the operable voltage of control unit 36 is set in a range of 2 V above or below 24 V, the output voltage of DC/DC converter 35 is set to about 22 V and the output voltage of AC/DC converter 34 is set to about 26 V.

Hence, power storage control device 11 supplies power to control unit 36 by prioritizing the power supplied from power system 12 over the power supplied from storage battery 31. Thus, by preferentially supplying power from other than storage battery 31 to control unit 36, it is possible to suppress consumption of valuable power stored in storage battery 31. Further, charging loss occurs when storage battery 31 is charged, so that it is possible to improve power efficiency as a whole by suppressing consumption of power stored in storage battery 31. Furthermore, by reducing the amount of power discharged at all times from storage battery 31, it is possible to avoid a risk that storage battery 31 causes over discharge. Still further, it is possible to avoid that a user feels that the amount of remaining charged power decreases even when storage battery 31 is not used.

Moreover, power storage control device 11 is configured to supply power at all times from storage battery 31 to control unit 36 through DC/DC converter 35 even upon a normal time, so that, even when, for example, blackout occurs and power supply from power system 12 stops, power storage control device 11 can continue operating.

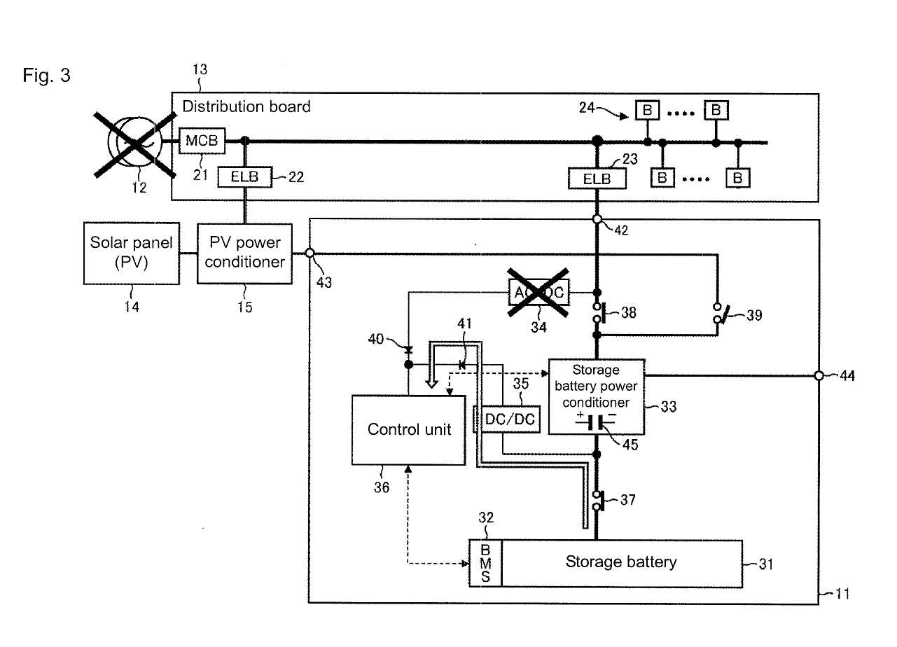

FIG. 3 illustrates a route of power supplied to control unit 36 upon blackout.

As illustrated in FIG. 3, when power supply from power system 12 stops and AC/DC converter 34 cannot supply power to control unit 36, power is supplied to from storage battery 31 to control unit 36 through DC/DC converter 35 as indicated by an outlined arrow.

When, for example, blackout occurs while power is obtained from the power system in a system in which a plurality of power supply routes is switched, there is a concern that a power supply route cannot be switched and the system stops. In contrast with this, even when control unit 36 obtains power from both of power system 12 and storage battery 31 and blackout occurs, power storage control device 11 does not require an operation of switching a power supply route and can supply power from storage battery 31 to control unit 36.

Consequently, power storage control device 11 can avoid that control unit 36 stops due to blackout, and power storage control device 11 can continue operating. Consequently, power storage control device 11 can be effectively taken advantage of for use in a power storage system for a disaster countermeasure upon blackout.

In this regard, in the system having power storage battery 31, relay 37 connected to storage battery 31 is generally an important part for securing safety. Hence, power storage control device 11 is desirably operated to check the operation of relay 37 on a regular basis in order to detect abnormality (e.g. welding of a contact point) of relay 37. For example, control unit 36 performs control of turning on and off relay 37 on a regular basis and checks whether or not relay 37 is operating at all times.

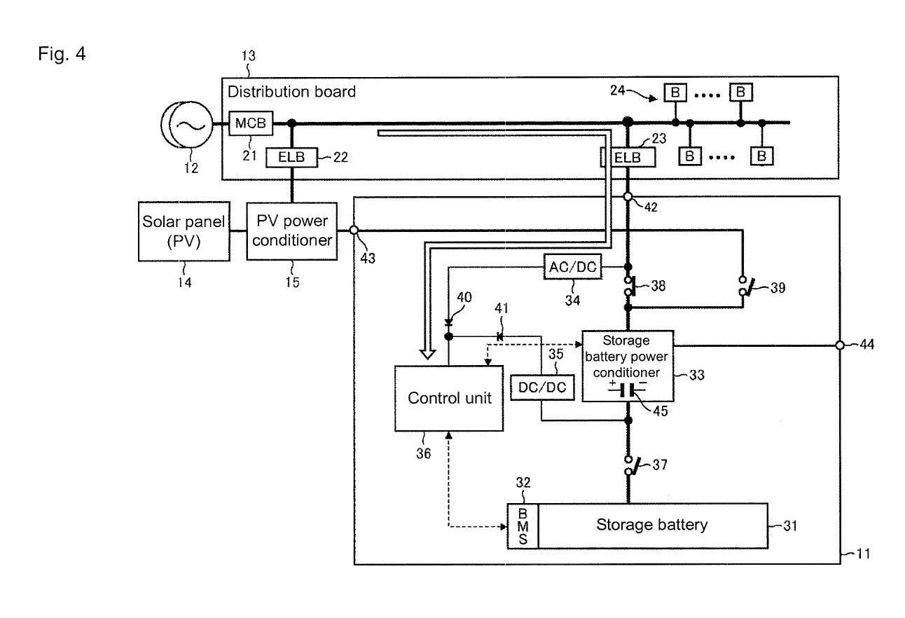

Hence, while the operation of relay 37 is checked, relay 37 is placed in an off state (a contact point is opened) as illustrated in FIG. 4. In this state, control unit 36 can operate by obtaining the power supplied from power system 12 through AC/DC converter 34 as indicated by a bold outlined arrow.

By the way, it is normally difficult to predict that blackout occurs. Hence, as illustrated in FIG. 4, when blackout occurs while the operation of relay 37 is checked and relay 37 is placed in an off state, a situation that power cannot be supplied from neither power system 12 nor storage battery 31 to control unit 36 occurs. When such a situation occurs, power stored in smoothing capacitor 45 of storage battery power conditioner 33 is supplied to control unit 36 in storage power control device 11.

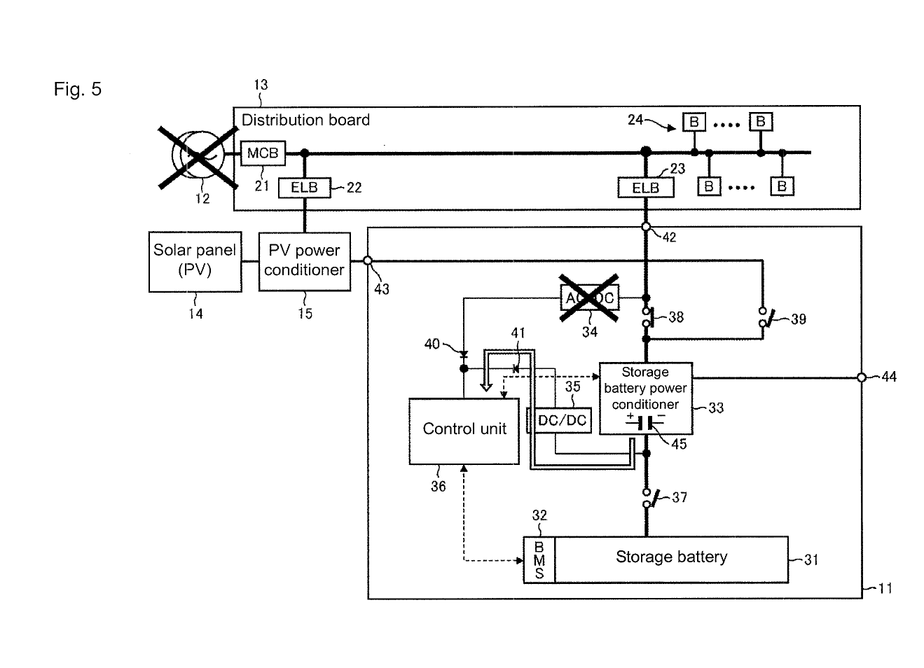

FIG. 5 illustrates a route of power supplied to control unit 36 when blackout occurs while the operation of relay 37 is checked.

FIG. 5 illustrates a power route to power storage control device 11 when blackout occurs while the operation of relay 37 is checked, as an outlined arrow. That is, when blackout occurs while the operation of relay 37 is checked, power stored in smoothing capacitor 45 of storage battery power conditioner 33 is DC/DC-converted by DC/DC converter 35 and is supplied to control unit 36. As described above, storage battery power conditioner 33 has smoothing capacitor 45 of a relatively large capacity on the DC side, and, while storage battery power conditioner 33 operates, power is stored in smoothing capacitor 45.

Consequently, even when blackout occurs in a state where relay 37 is turned off while the operation of relay 37 is checked, and power supply from power system 12 stops, power storage control device 11 can supply power to control unit 36 using power stored in smoothing capacitor 45 of storage battery power conditioner 33.

Consequently, when control unit 36 detects that blackout occurs while the operation of relay 37 is checked, control unit 36 preferentially performs control of turning on relay 37 (connecting a contact point) while control unit 36 can be driven by power stored in smoothing capacitor 45. When relay 37 is turned on, the power stored in storage battery 31 is supplied to control unit 36, so that control unit 36 can continue operating.

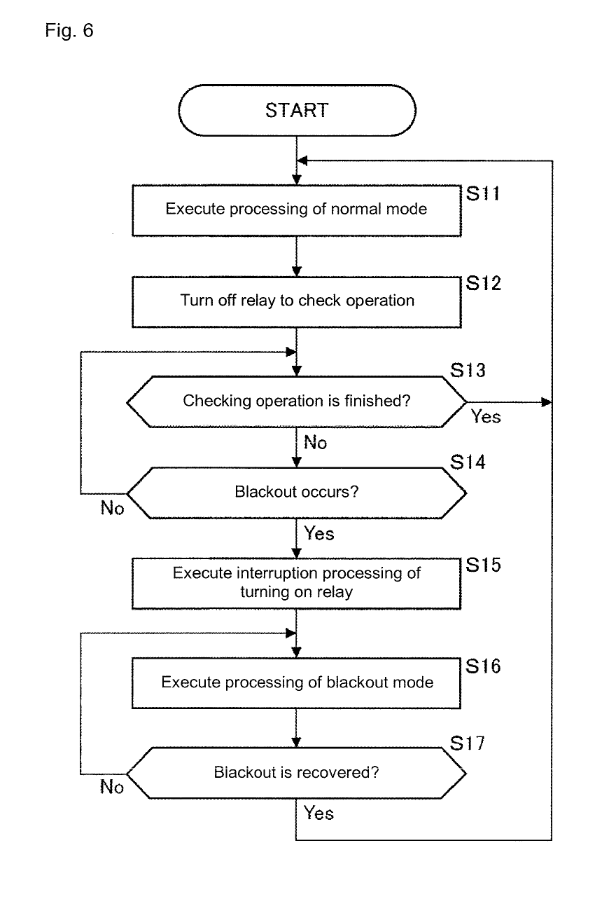

Processing performed by control unit 36 when blackout occurs while the operation of relay 37 is checked will be described with reference to a flowchart of FIG. 6.

When, for example, control unit 36 activates upon a normal time when blackout does not occur, processing starts, and control unit 36 executes processing of a normal mode in step S11. For example, control unit 36 executes processing of controlling storage battery power conditioner 33 such that storage battery 31 is charged by power from power system 12 and the power stored in storage battery 31 is supplied to a load which is not illustrated through distribution board 13. Further, the processing of the normal mode is set to check the operation of relay 37 on a regular basis and, when timing comes to check the operation of relay 37, the processing moves to step S12.

In step S12, control unit 36 turns off relay 37 to check the operation, and check the operation of relay 37.

In step S13, control unit 36 determines whether or not checking the operation of relay 37 is finished, and, when it is determined that checking the operation of relay 37 is finished, processing returns to step S11 and the same processing is subsequently repeated.

Meanwhile, when it is determined in step S13 that checking the operation of relay 37 is not finished, the processing moves to step S14 and control unit 36 determines whether or not blackout occurs.

When control unit 36 determines that blackout does not occur in step S14, the processing returns to step S13 and the same processing is subsequently repeated. Meanwhile, when control unit 36 determines that blackout occurs, that is, when blackout occurs while the operation of relay 37 is checked in step S14, the processing moves to step S15. In addition, in this case, as described with reference to FIG. 5, control unit 36 receives a supply of the power stored in smoothing capacitor 45 of storage battery power conditioner 33.

In step S15, control unit 36 stops all processings which are being executed, and executes interruption processing of turning off relay 37. Consequently, relay 37 which is turned off while the operation is checked is turned on, and the power stored in storage battery 31 is supplied to control unit 36 through relay 37.

In step S16, control unit 36 executes processing of a blackout mode, and power storage control device 11 continues operating.

In step S17, control unit 36 determines whether or not blackout is recovered and, when it is determined that blackout is not recovered, the processing returns to step S16 and the processing of the blackout mode is continuously executed.

Meanwhile, when it is determined that blackout is recovered in step S17, the processing returns to step S11 and is switched to the processing of the normal mode, and the same processing is subsequently repeated.

As described above, in power storage control device 11, even when blackout occurs while the operation of relay 37 is checked, control unit 36 which is driven by power supplied from smoothing capacitor 45 preferentially performs processing of turning on relay 37, so that power stored in storage battery 31 is supplied to control unit 36 through relay 37 and power storage control device 11 can continue operating.

Further, power storage control device 11 is configured to use smoothing capacitor 45 built in storage battery power conditioner 33, so that it is possible to handle blackout while the operation of relay 37 is checked without additionally providing an auxiliary power supply to an outside. Consequently, power storage control device 11 does not require maintenance which is required when such an auxiliary power supply is provided.

Further, as described above, power storage control device 11 is set to preferentially supply power from storage battery 31 to control unit 36, so that smoothing capacitor 45 maintains as much power which can be stored as possible upon a normal time when blackout does not occur. Consequently, it is possible to store power which control unit 36 requires performing a minimum operation when blackout occurs, in smoothing capacitor 45.

Thus, by using smoothing capacitor 45 built in storage battery power conditioner 33, power storage control device 11 can handle blackout which occurs while the operation of relay 37 is checked, without providing a new auxiliary power supply outside. Consequently, it is possible to improve reliability of power storage control device 11.

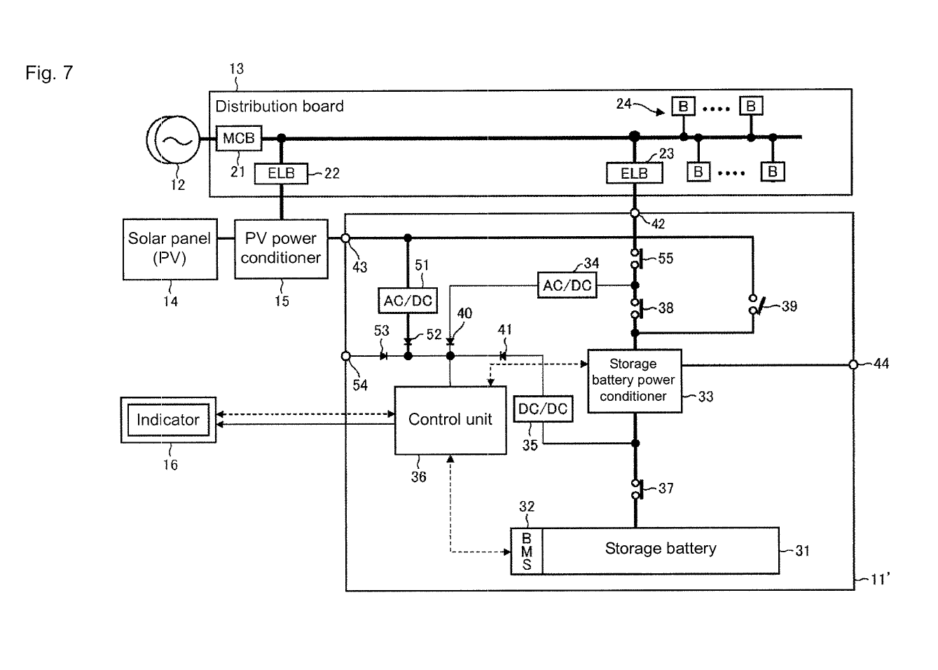

Next, FIG. 7 is a block diagram illustrating a configuration example of a power storage control device of a second embodiment to which the present technology is applied. In addition, components of power storage control device 11′ illustrated in FIG. 7 common to power storage control device 11 in FIG. 1 will be assigned the same reference numerals, and will not be described in detail.

That is, as illustrated in FIG. 7, power storage control device 11′ employs the same configuration as the configuration of power storage control device 11 in FIG. 1 in including storage battery 31, battery management system 32, storage battery power conditioner 33, AC/DC converter 34, DC/DC converter 35, control unit 36, relays 37 to 39, reverse flow preventing units 40 and 41 and connection terminals 42 to 44. Meanwhile, power storage control device 11′ employs a different configuration from that of power storage control device 11 in FIG. 1 in including AC/DC converter 51, reverse flow preventing units 52 and 53, connection terminal 54 and relay 55.

Further, power storage control device 11′ is connected with power system 12 through distribution board 13, is connected with solar panel 14 through PV power conditioner 15 and is connected with indicator 16. Indicator 16 has a display formed with, for example, a liquid crystal panel, and transmits and receives a control signal by communicating with control unit 36 and displays an image matching an image signal supplied from control unit 36, on the display. Further, power required to drive indicator 16 is supplied from control unit 36.

An input terminal of AC/DC converter 51 is connected to a wiring between relay 39 and connection terminal 43, and an output terminal of AC/DC converter 51 is connected to control unit 36 through reverse flow preventing unit 52. As described above, connection terminal 43 is connected to an autonomous output terminal of PV power conditioner 15, and power outputted from the autonomous output terminal of PV power conditioner 15 is supplied to AC/DC converter 51 through connection terminal 43, so that AC/DC converter 51 can AC/DC-convert the power and supply the power to control unit 36.

Reverse flow preventing units 52 and 53 and reverse flow preventing units 40 and 41 regulate directions of currents such that the power outputted from AC/DC converter 34, the power outputted from DC/DC converter 35, the power outputted from AC/DC converter 51 and the power supplied from an outside through connection terminal 54 are inputted only to control unit 36.

Connection terminal 54 is a terminal which connects with a maintenance/activation external power source from an outside, and connection terminal 54 is connected to control unit 36 through reverse flow preventing unit 53.

Relay 55 is disposed between a connection point between AC/DC converter 34 and relay 38, and connection terminal 42, and turns on and off a wiring according to the control of control unit 36.

Power storage control device 11′ configured in this way is provided with a route through which control unit 36 obtains power from power system 12 through AC/DC converter 34, a route through which control unit 36 obtains power from storage battery 31 through DC/DC converter 35, a route through which control unit 36 obtains power from an autonomous output terminal of PV power conditioner 15 through AC/DC converter 51, and a route through which control unit 36 obtains power from a maintenance/activation power source connected to connection terminal 54.

When, for example, power storage control device 11′ is in conjunction with power system 12, control unit 36 receives a supply of power supplied from power system 12 through AC/DC converter 34, and receives a supply of power stored in storage battery 31 through DC/DC converter 35. In addition, PV power conditioner 15 stops an output of power from an autonomous output terminal.

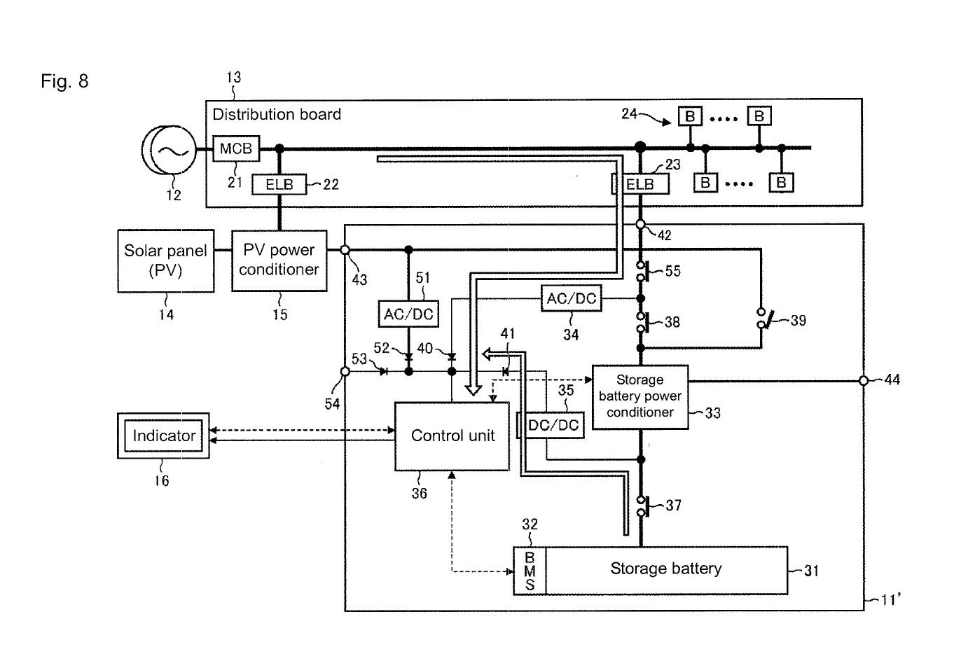

For example, FIG. 8 illustrates power routes of power storage control device 11′ upon a normal time when blackout does not occur, as outlines arrows. That is, upon a normal time, power supplied from power route 12 to power storage control device 11′ through distribution board 13 is AC/DC-converted in AC/DC converter 34, and is supplied to control unit 36 along a power supply route indicated by a bold outlined arrow. Similarly, power outputted from storage battery 31 is DC/DC-converted by DC/DC converter 35, and is supplied to control unit 36 along a power supply route indicated by a thin outlined route.

In this regard, similar to power storage control device 11 in FIG. 1, output voltages of AC/DC converter 34 and DC/DC converter 35 are set such that power supplied from power system 12 is prioritized over power supplied from storage battery 31.

In this regard, when control unit 36 detects that abnormality occurs in the system, power storage control device 11′ turns off relays 37 and 55, and is set to prevent occurrence of a danger related to storage battery 31. When, for example, control unit 36 communicates with battery management system 32 and a temperature of storage battery 31 becomes abnormally high or when leakage of storage battery 31 occurs, control unit 36 detects that abnormality occurs in the system. Further, a power supply route upon a normal time is blocked as a result that control unit 36 turns off relays 37 and 55, and therefore power storage control device 11′ stops operating.

In such a case, it is necessary to maintain power storage control device 11′, analyze a cause that power storage control device 11′ stops operating, supply power to control unit 36 and drive control unit 36 to tentatively operate power storage control device 11′ again. Hence, power storage control device 11′ is configured to allow a maintenance person to connect a maintenance power source to connection terminal 54, and supply power to control unit 36 through connection terminal 54.

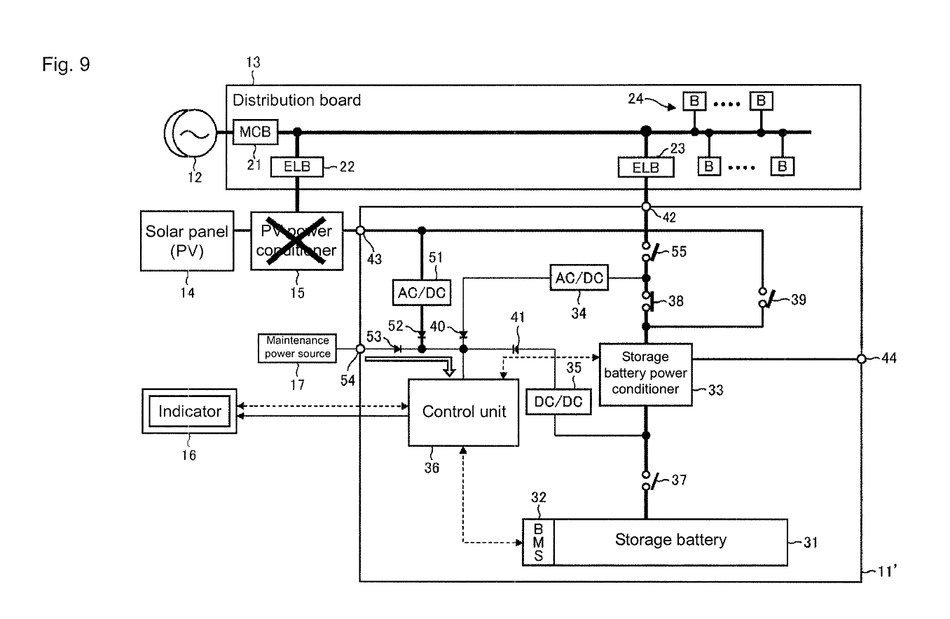

That is, as illustrated in FIG. 9, power storage control device 11′ supplies power to control unit 36 from maintenance power source 17 connected to connection terminal 54 even in a state where relays 37 and 55 are turned off. Consequently, control unit 36 can be activated by power from maintenance power source 17, and a maintenance person can obtain a data log of the system and check a status of each unit which forms power storage control device 11′.

Further, when, for example, solar panel 14 generates power while blackout occurs, PV power conditioner 15 outputs power from the autonomous output terminal. Consequently, in storage power control device 11′, control unit 36 can obtain power outputted from the autonomous output terminal of PV power conditioner 15 through AC/DC converter 51, and obtain power stored in storage battery 31 through DC/DC converter 35.

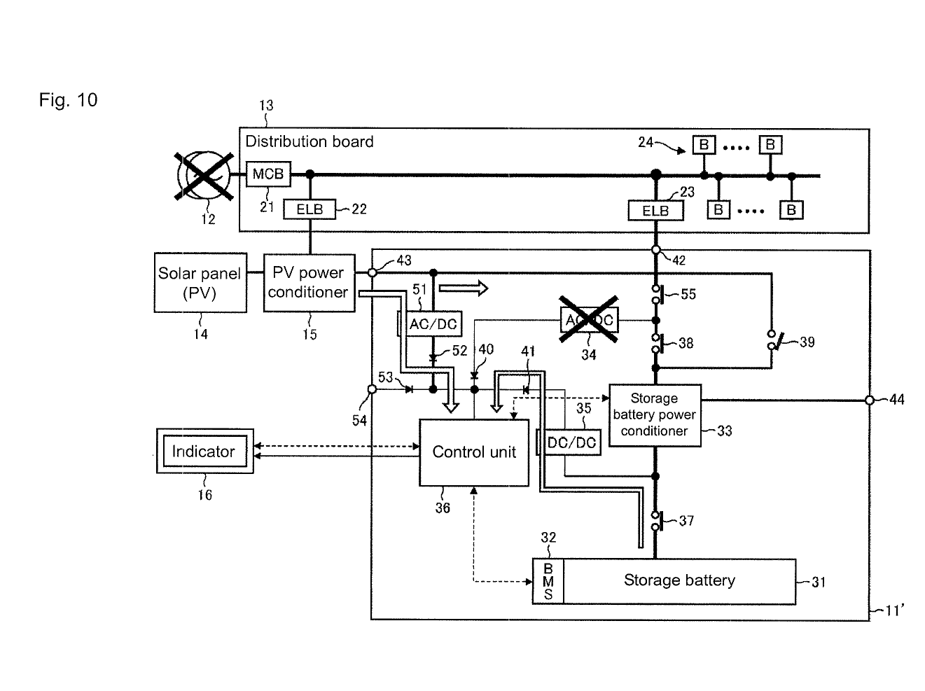

FIG. 10 illustrates power routes of power storage control device 11′ as outlined arrows when solar panel 14 generates power while blackout occurs.

As illustrated in FIG. 10, power storage control device 11′ supplies power outputted from the autonomous output terminal of PV power conditioner 15 to control unit 36 along a power supply route indicated by a bold outlined arrow. Similarly, power outputted from storage battery 31 is supplied to control unit 36 along a power supply route indicated by a thin outlined arrow.

Further, in power storage control device 11′, a voltage value of an output voltage of AC/DC converter 51 is set higher than a voltage value of an output voltage of DC/DC converter 35. Consequently, power storage control device 11′ supplies power outputted from the autonomous output terminal of PV power conditioner 15 preferentially over power of storage battery 31, to control unit 36.

Consequently, when control unit 36 preferentially obtains power outputted from the autonomous output terminal of PV power conditioner 15, power storage control device 11′ can suppress consumption of power stored in storage battery 31. Further, by using an output from the autonomous output terminal of PV power conditioner 15 as an activation power source, power storage control device 11′ can autonomously recover the system from a state where the amount of remaining power of storage battery 31 decreases during blackout and relay 37 is paralleled off.

When, for example, blackout occurs at a night time or on a rainy day, control unit 36 cannot obtain power from neither power system 12 nor PV power conditioner 15.

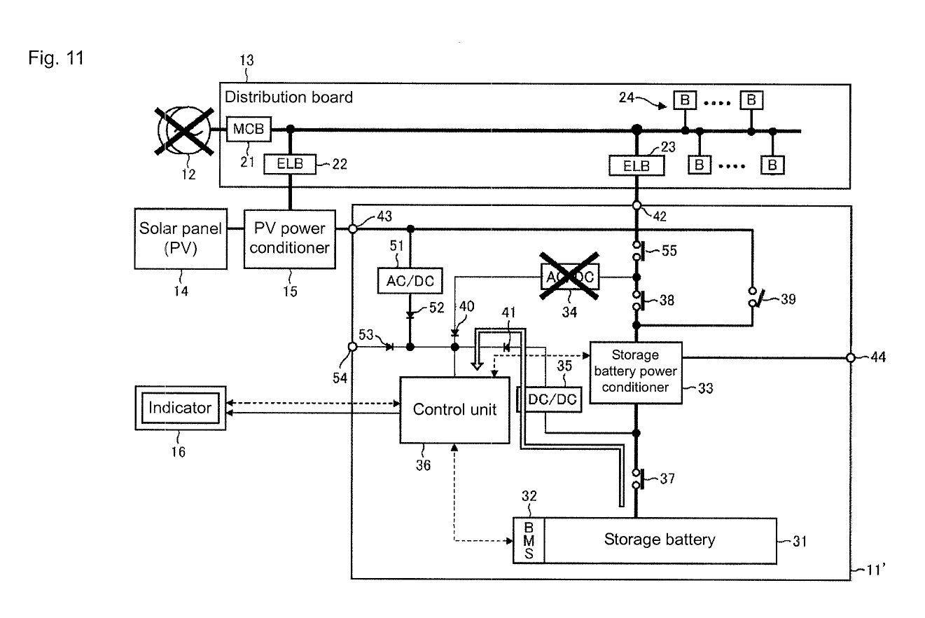

In this case, as illustrated in FIG. 11, in power storage control device 11′, control unit 36 can be driven by obtaining power from storage battery 31. That is, even when power from power system 12 is interrupted at a moment when blackout occurs, in power storage control device 11′, control unit 36 obtains power from storage battery 31 in parallel to power system 12 and can operate irrespectively of blackout.

By the way, when blackout continues and a bad weather continues, control unit 36 continues obtaining power from storage battery 31, and therefore the amount of remaining power of storage battery 31 continues decreasing. Further, when the amount of remaining power of storage battery 31 is a certain value or less, control unit 36 performs control of turning off relay 37 and protecting storage battery 31 such that more power cannot be obtained from storage battery 31 to avoid deterioration of storage battery 31 due to over discharge. In addition, when blackout occurs in a state where the amount of remaining power of storage battery 31 is little, control unit 36 immediately performs control of turning off relay 37 and protecting storage battery 31.

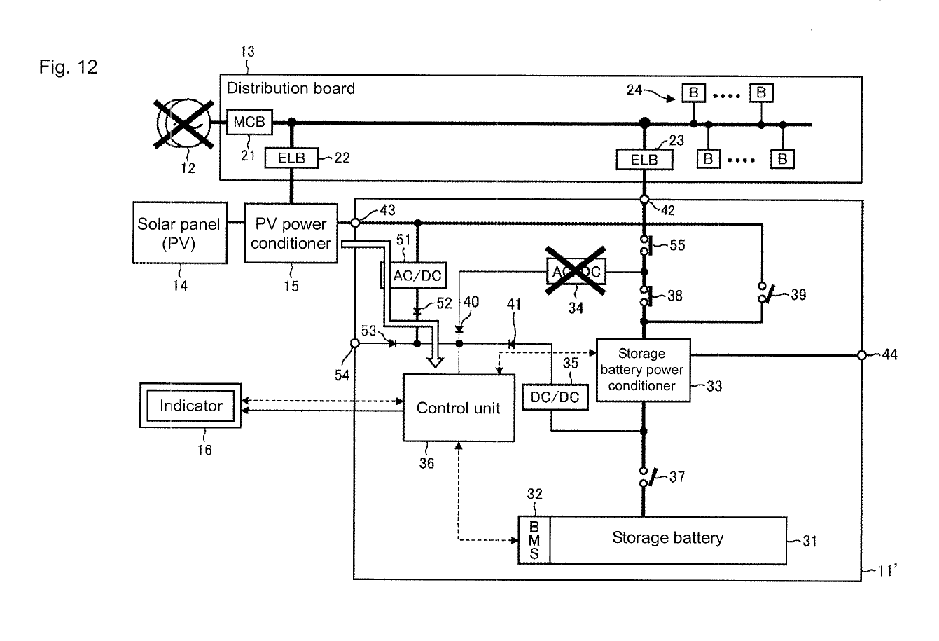

When the weather gets better and solar panel 14 generates power in this state, as illustrated in FIG. 12, the power outputted from the autonomous output terminal of PV power conditioner 15 is supplied to control unit 36 through AC/DC converter 51. Consequently, control unit 36 activates, and power storage control device 11′ can operate again.

Further, in this case, control unit 36 turns on relay 39, supplies the power outputted from the autonomous output terminal of PV power conditioner 15 to storage battery power conditioner 33, and charges storage battery 31.

Thus, the power supply route through which power outputted from the autonomous output terminal of PV power conditioner 15 is supplied to control unit 36 through AC/DC converter 51 is provided in power storage control device 11′, so that, even when power storage control device 11′ stops operating, if the weather is recovered even before blackout is recovered, it is possible to operate the system again.

Further, it is assumed that power generated by solar panel 14 is not stable when power storage control device 11′ is operated again in response to recovery of the weather. Particularly at dawn, the amount of power generation of solar panel 14 is a little, so that it is possible to sufficiently obtain power for activating relay 37 or storage battery power conditioner 33. In this case, for example, it is assumed that control unit 36 is activated by power generated by solar panel 14, the power runs short even though control unit 36 tries to turn on relay 37 and chattering of relay 37 occurs.

Then, control unit 36 performs control of turning on relay 37 after a certain period of time spent until power generated by solar panel 14 becomes stable passes after solar panel 14 starts generating power.

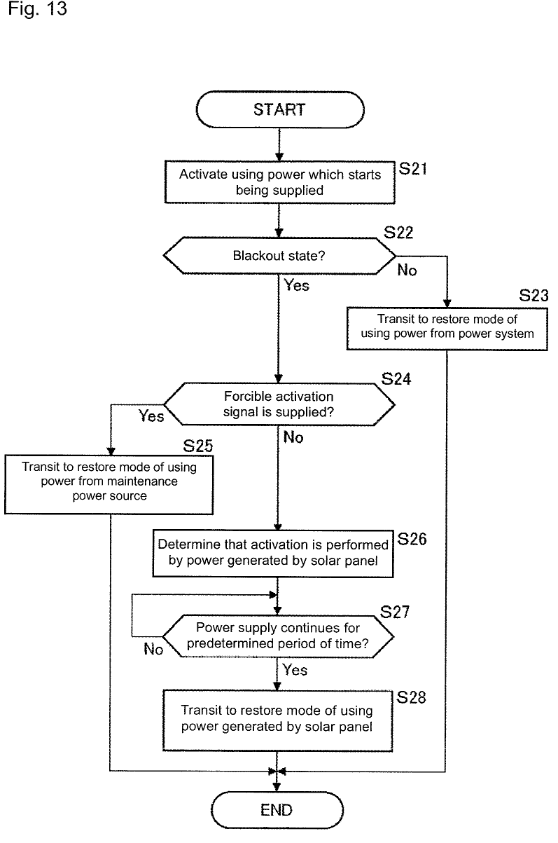

Next, activation processing executed by control unit 36 will be described with reference to FIG. 13.

As described above, when power supply starts while control unit 36 stops operating in a state where solar panel 14 does not generate power while blackout occurs, the amount of remaining power of storage battery 31 becomes a certain value or less and relay 37 is turned off, processing starts.

In step S21, control unit 36 is activated by power which starts being supplied.

In step S22, control unit 36 determines whether or not a state is a blackout state. When, for example, blackout is recovered, power is also supplied from power system 12 to storage battery power conditioner 33, so that it is possible for control unit 36 to determine whether or not the state is the blackout state by trying communication with storage battery power conditioner 33.

In step S22, when control unit 36 determines that the state is not the blackout state, that is, when power for activating control unit 36 is supplied from power system 12, processing moves to step S23. In step S23, control unit 36 transitions to a restore mode of restoring power storage control device 11′ using power from power system 12.

Meanwhile, when control unit 36 determines that the state is the blackout state in step S22, the processing moves to step S24, and control unit 36 determines whether or not a forcible activation signal is supplied. When, for example, the maintenance person connects maintenance power source 17 (see FIG. 9) to connection terminal 54, and supplies power to control unit 36 through connection terminal 54, a forcible activation signal is additionally supplied to control unit 36.

In step S24, when control unit 36 determines that the forcible activation signal is supplied, the processing moves to step S25, and control unit 36 transitions to the restore mode of restoring power storage control device 11′ using power from maintenance power source 17.

Meanwhile, when control unit 36 determines that the forcible activation signal is not supplied in step S24, the processing moves to step S26, and control unit 36 determines that control unit 36 is activated by power generated by solar panel 14 and outputted from the autonomous output terminal of PV power conditioner 15. That is, in this case, power is not supplied from power system 12 and maintenance power source 17 and relay 37 is turned off in a state before activation of control unit 36, so that it is possible to determine that control unit 36 is activated by power generated by solar panel 14 and outputted from the autonomous output terminal of PV power conditioner 15.

In step S27, for example, control unit 36 determines whether or not power supply continues for a certain period of time after activation, by using a timer counter which is not illustrated, and stands by for processing until it is determined that power supply continues. In this regard, control unit 36 stops operating when, for example, control unit 36 stands by until a certain period of time passes, power generation by solar panel 14 is not stable and power supply stops, and processing is resumed from step S21 when power supply starts again.

Further, in step S27, when control unit 36 determines that power supply continues for a certain period of time after activation, the processing moves to step S28. In step S28, control unit 36 determines that power generation performed by solar panel 14 becomes stable and transitions to the restore mode of restoring power storage control device 11′ using power generated by solar panel 14 and outputted from the autonomous output terminal of PV power conditioner 15. That is, in this case, in this restore mode, relay 37 is turned on, relay 39 is turned on, power outputted from the autonomous output terminal of PV power conditioner 15 is supplied to storage battery power conditioner 33 and storage battery power conditioner 33 is commanded to charge storage battery 31.

Further, activation processing is finished after the processing in steps S23, S25 and S28.

As described above, power storage control device 11′ turns on relay 37 after a certain period of time in which power generated by solar panel 14 becomes stable passes after solar panel 14 starts generating power and, consequently, can reliably charge storage battery 31 while avoiding occurrence of chattering of relay 37.

Further, control unit 36 can obtain power from a plurality of routes, so that, even when blackout occurs or a bad weather continues, power storage control device 11′ can activate control unit 36 and effectively use power both upon a normal time and upon blackout.

In addition, a plurality of routes through which control unit 36 obtains power may be part of the above routes.

In addition, the above series of processing can be executed by hardware and can be executed by software. When the series of processing is executed by software, a program configuring this software is installed from a program recording medium to a computer embedded in dedicated hardware or to, for example, a general-purpose personal computer which can execute various functions by installing various programs.

Further, these programs can be stored in a memory unit in advance. In addition, these programs can be installed in the computer through a communication unit formed with a network interface or through a drive which drives removable media such as magnetic disks (including flexible disks), optical disks (CD-ROMs (Compact Disc-Read Only Memory) and DVDs (Digital Versatile Disc)), magnetooptical disks and semiconductor memories.

Further, each processing described with reference to the above flowchart may not be necessarily processed in the time sequence in order described as the flowchart, and also includes processing (e.g. parallel processing or processing by an object) executed individually or in parallel. In addition, in this description, the system refers to an entire apparatus formed with a plurality of apparatuses.

In addition, the embodiment is not limited to the above-described embodiment, and can be variously changed as long as the changes do not deviate from the spirit of the present disclosure.

### DESCRIPTION OF SYMBOLS

11 Power storage control device
12 Power system
13 Distribution board
14 Solar panel
15 PV power conditioner
16 Indicator
17 Maintenance power source
21 Molded case circuit breaker
22 and 23 Earth leakage circuit breaker
24 Circuit breaker
31 Storage battery
32 Battery management system
33 Storage battery power conditioner
34 AC/DC converter
35 DC/DC converter
36 Control unit
37 to 39 Relay
40 and 41 Reverse flow preventing unit
42 to 44 Connection terminal
43 Smoothing capacitor
51 AC/DC converter
52 and 53 Reverse flow preventing unit
54 Connection terminal
55 Relay

1-9. (canceled)

10. A power storage control device comprising:
a first power converter configured to convert power supplied from a power system;
a second power converter configured to convert power outputted from a storage battery configured to store power;
a controller configured to be driven by the power outputted from the first power converter and the power outputted from the second power converter, and control charging and discharging of the storage battery; and
a third power converter configured to convert power outputted from a power generating device configured to generate power using natural energy, and output the power to the controller, wherein
a voltage value of the power outputted from the first power converter is set higher than a voltage value of the power outputted from the second power converter, and
a forcible activation signal is supplied to the controller when the power storage control device is configured to be connected with an external power source configured to supply power to the controller from an outside and the power is supplied from the external power source to the controller.

11. The power storage control device according to claim 10, wherein the controller performs control of supplying the power outputted from the power generating device to the storage battery when the controller determines that the controller is activated by the power outputted from the power generating device through the third power converter and supply of the power continues for a certain period of time after the activation.

12. The power storage control device according to claim 10, wherein a voltage value of the power outputted from the third power converter is set higher than a voltage value of the power outputted from the second power converter.

13. The power storage control device according to claim 10, further comprising an adjuster configured to adjust the power supplied from the power system according to a charged state of the storage battery, and charge the power supplied from the power system to the storage battery, wherein
a wiring configured to connect the adjuster and the storage battery, and the controller are connected through the second power converter, and
the adjuster is configured to comprise a capacitor of a predetermined capacity built in a side of the adjuster connected to the storage battery.

14. The power storage control device according to claim 13, further comprising a first switch configured to be connected to the storage battery, and a wiring between the second power converter and the adjuster,
wherein the controller is driven by power supplied from the capacitor built in the adjuster, and preferentially performs processing of switching the first switch to a closed state when blackout occurs in an opened state of the first switch.

15. A method of controlling a power storage control device, the power storage control device comprising:
a first power converter configured to convert power supplied from a power system;
a second power converter configured to convert power outputted from a storage battery configured to store the power;
a controller configured to be driven by the power outputted from the first power converter and the power outputted from the second power converter, and control charging and discharging of the storage battery; and
a third power converter configured to convert power outputted from a power generating device configured to generate power using natural energy, and output the power to the controller, wherein
a voltage value of the power outputted from the first power converter is set higher than a voltage value of the power outputted from the second power converter,
a forcible activation signal is supplied to the controller when the power storage control device is configured to be connected with an external power source configured to supply power to the controller from an outside and the power is supplied from the external power source to the controller, and
the method comprises a step of, at the controller, when the controller determines that the controller is activated by the power outputted from the power generating device through the third power converter and supply of the power continues for a certain period of time after the activation, performing control of supplying the power outputted from the power generating device to the storage battery.

16. A program executed by a computer of a power storage control device, the power storage control device comprising:
a first power converter configured to convert power supplied from a power system;
a second power converter configured to convert power outputted from a storage battery configured to store the power;
a controller configured to be driven by the power outputted from the first power converter and the power outputted from the second power converter, and control charging and discharging of the storage battery; and
a third power converter configured to convert power outputted from a power generating device configured to generate power using natural energy, and output the power to the controller, wherein
a voltage value of the power outputted from the first power converter is set higher than a voltage value of the power outputted from the second power converter,
a forcible activation signal is supplied to the controller when the power storage control device is configured to be connected with an external power source configured to supply power to the controller from an outside and the power is supplied from the external power source to the controller, and
the program causes the computer to execute processing comprising, at the controller, performing control of supplying the power outputted from the power generating device to the storage battery when the controller determines that the controller is activated by the power outputted from the power generating device through the third power converter and supply of the power continues for a certain period of time after the activation.

17. A power storage system comprising:
a storage battery configured to store power;
a first power converter configured to convert power supplied from a power system;
a second power converter configured to convert power outputted from the storage battery;
a controller configured to be driven by the power outputted from the first power converter and the power outputted from the second power converter, and control charging and discharging of the storage battery; and
a third power converter configured to convert power outputted from a power generating device configured to generate power using natural energy, and output the power to the controller, wherein
a voltage value of the power outputted from the first power converter is set higher than a voltage value of the power outputted from the second power converter, and
a forcible activation signal is supplied to the controller when the power storage control device is configured to be connected with an external power source configured to supply power to the controller from an outside and the power is supplied from the external power source to the controller.
